(19) United States
(12) Patent Application Publication
(10) Pub. No.: US 2018/0240116 A1
(43) Pub. Date: Aug. 23, 2018

(54) ERROR HANDLING FOR REQUESTS FROM MULTI-FUNCTION PRINT DEVICES

(71) Applicants: Jayasimha Nuggehalli, Cupertino, CA (US); Bhushan Nadkarni, Santa Clara, CA (US); Srikrishna Narasimhan, Sunnyvale, CA (US); Zhenyu Lu, Sunnyvale, CA (US)

(72) Inventors: Jayasimha Nuggehalli, Cupertino, CA (US); Bhushan Nadkarni, Santa Clara, CA (US); Srikrishna Narasimhan, Sunnyvale, CA (US); Zhenyu Lu, Sunnyvale, CA (US)

(73) Assignee: RICOH COMPANY, LTD., TOKYO (JP)

(21) Appl. No.: 15/436,705

(22) Filed: Feb. 17, 2017

(51) Int. Cl. G06Q 20/40; G06Q 30/06; G06F 3/12

(52) U.S. Cl. CPC G06Q 20/407; G06Q 30/0613; G06F 3/1291; G06F 3/121; G06F 3/1272

(57) ABSTRACT

A server transaction processing service implemented on the apparatus receives requests to authorize user sessions on multi-function print devices. A server application service implemented on the apparatus receives service task requests, which are requests for services that may be at least partially performed at one or more external servers. The application service then sends the service task requests to the appropriate external servers. The transaction processing service receives requests to end active user sessions. Then the transaction processing service is configured to determine whether any service task requests from user sessions were unsuccessfully executed and generate a subset of unsuccessfully executed service task requests. The transaction processing service may generate refund requests for each user session that contained unsuccessfully executed service task requests and send the refund requests to an authorization and capture service for processing.

### RELATED APPLICATION DATA AND CLAIM OF PRIORITY

This application is related to U.S. patent application Ser. No. 15/400,843 (Attorney Docket No. 49986-0887) entitled System for MODIFYING A SET OF APPLICATION SERVICES ON MULTI-FUNCTION PRINT DEVICES, filed Jan. 6, 2017, U.S. patent application Ser. No. 15/400,862 (Attorney Docket No. 49986-0894) entitled System for MODIFYING A SET OF APPLICATION SERVICES ON MULTI-FUNCTION PRINT DEVICES, filed Jan. 6, 2017 and U.S. patent application Ser. No. ______ (Attorney Docket No. 49986-0895) entitled System for ERROR HANDLING FOR REQUESTS FROM MULTI-FUNCTION PRINT DEVICES, filed ______ the contents all of which are incorporated by reference in their entirety for all purposes as if fully set forth herein.

### BACKGROUND

### Field of the Invention

Embodiments relate generally to managing transaction request errors for multiple multi-function print devices.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Managing services on distributed multi-function print devices includes the ability to manage and configure multiple different service requests for external services on multiple devices located in different locations. Among the many challenges involved in managing multiple devices over different locations is the ability to handle service request failures and errors and consolidating the transaction failures and errors such that charge request failures and/or service requests may be automatically retried without the need to manually request additional transaction charges.

One such technique for managing service request and transaction request failures is to automatically retry or refund all individual failed requests. However, refunding all individual service requests may result in an unnecessarily large number of refund requests if the service task failures include multiple different external services. Therefore techniques for efficiently consolidating errors and/or failures and automatically reconciling the errors and/or failures is desired.

### SUMMARY

An apparatus includes one or more processors, one or more memories communicatively coupled to the one or more processors and a multi-function print server transaction processing service executing on the apparatus. The multi-function print server transaction processing service receives requests to authorize user sessions on multi-function print devices. A multi-function print server application service executing on the apparatus is configured to receive service task requests, which are requests for services that may be at least partially performed at one or more external servers. The multi-function print server application service then sends the service task requests to the appropriate external servers. The multi-function print server transaction processing service receives requests to end active user sessions. Then the multi-function print server transaction processing service is configured to determine whether any service task requests from user sessions were unsuccessfully executed and generate a subset of unsuccessfully executed service task requests. Then the multi-function print server transaction processing service may generate refund requests for each user session that contained unsuccessfully executed service task requests and send the refund requests to an authorization and capture service for processing.

### BRIEF DESCRIPTION OF THE DRAWINGS

In the figures of the accompanying drawings like reference numerals refer to similar elements.

FIG. 1 is a diagram that depicts an arrangement for managing transaction processing errors related to services performed on multiple multi-function print devices.

FIGS. 2A and 2B are flow diagrams that depict an example method for processing transaction requests from two or more MFP devices.

FIG. 3 depicts example embodiments of database tables implemented by a multi-function print server to manage and track user sessions from multi-function print devices.

FIGS. 4A and 4B depict example embodiments of display screens displaying information related to multiple user sessions associated with a specific vendor-administrator account.

FIG. 5 is a flow diagram that depicts an example method for managing service task requests for a particular user session and determining and generating refund requests for unsuccessful service task requests during the user session.

FIG. 6 is a block diagram that depicts an example computer system upon which embodiments may be implemented.

### DETAILED DESCRIPTION

In the following description, for the purposes of explanation, numerous specific details are set forth in order to provide a thorough understanding of the embodiments. It will be apparent, however, to one skilled in the art that the embodiments may be practiced without these specific details. In other instances, well-known structures and devices are shown in flow diagram form in order to avoid unnecessarily obscuring the embodiments.

1. OVERVIEW

2. STRUCTURAL OVERVIEW

3. MFP DEVICE USER SESSIONS

4. TRANSACTION PROCESSING SERVICE
4.1. TRANSACTION AUTHORIZATION REQUESTS
4.2. TRANSACTION CAPTURE REQUESTS
4.3. RECONCILING FAILED CAPTURE REQUESTS

5. SERVICE TASK RECONCILIATION
5.1. TRACKING SERVICE TASKS REQUESTED IN A USER SESSION
5.2. RECONCILING FAILED SERVICE TASKS FROM USER SESSIONS

6. IMPLEMENTATION MECHANISMS

### 1. Overview

A multi-function print server administration service implemented on a server computer receives a request, by a user associated with either a vendor-administrator user account or a system administrator account, to modify a first set of one or more application services enabled on one or more multi-function print devices associated with the vendor-administrator user account. In response to receiving the requests, the multi-function print server generates a modified first set of one or more application services, which implements a modification to the one or more application services based on the received request to modify the first set of one or more application services. The multi-function print server administration service enables the modified first set of one or more application services on the one or more multi-function print devices.

A multi-function print server transaction processing service implemented on a server computer receives two or more transaction authorization requests from two or more multi-function print devices. The two or more transaction authorization requests represent requests to authorize payments of service transactions using user payment information supplied in the two or more transaction authorization requests. In response to receiving the two or more transaction authorization requests, the multi-function print server transaction processing service generates two or more transaction records, where the two or more transaction records are used to track transaction status of the transactions associated with the two or more transaction authorization requests. The multi-function print server transaction processing service then generates and sends two or more transaction record authorization requests to an authorization and capture service configured to authorize and process transaction requests. The multi-function print server transaction processing service then receives, from the authorization and capture service, two or more transaction authorization request acknowledgements for the two or more transaction authorization requests. The multi-function print server transaction processing service updates the two or more transaction records to reflect the acknowledgement received.

The multi-function print server transaction processing service then receives two or more transaction capture requests from the two or more MFP devices, corresponding to the two or more transaction authorization requests. Each of the two or more transaction capture requests include a request to charge a transaction amount for services rendered on the two or more MFP devices. In response to receiving the two or more transaction capture requests from the two or more MFP devices, the multi-function print server transaction processing service updates the two or more transaction records, associated with the two or more transaction authorization requests and generates and sends two or more transaction amount capture requests to the authorization and capture service. The multi-function print server transaction processing service then receives acknowledgements for the two or more transaction amount capture requests, where the acknowledgements indicate whether the transaction amount capture requests were successful or unsuccessful. The multi-function print server transaction processing service then determines if a subset of transaction records of the two or more transaction records contain unsuccessful transaction capture descriptions and generates and sends retry transaction amount capture requests to the authorization and capture service. The multi-function print server transaction processing service receives retry transaction capture acknowledgements for the retry transaction amount capture requests and updates the transaction records corresponding to the retry transaction amount capture requests.

A multi-function print server application service implemented on a server computer is configured to receive service task requests, which are requests for services that may be at least partially performed at one or more external servers. The multi-function print server application service then sends the service task requests to the appropriate external servers. The multi-function print server transaction processing service receives requests to end active user sessions. Then the multi-function print server transaction processing service is configured to determine whether any service task requests from user sessions were unsuccessfully executed and generate a subset of unsuccessfully executed service task requests. Then the multi-function print server transaction processing service may generate refund requests for each user session that contained unsuccessfully executed service task requests and send the refund requests to an authorization and capture service for processing.

### 2. Structural Overview

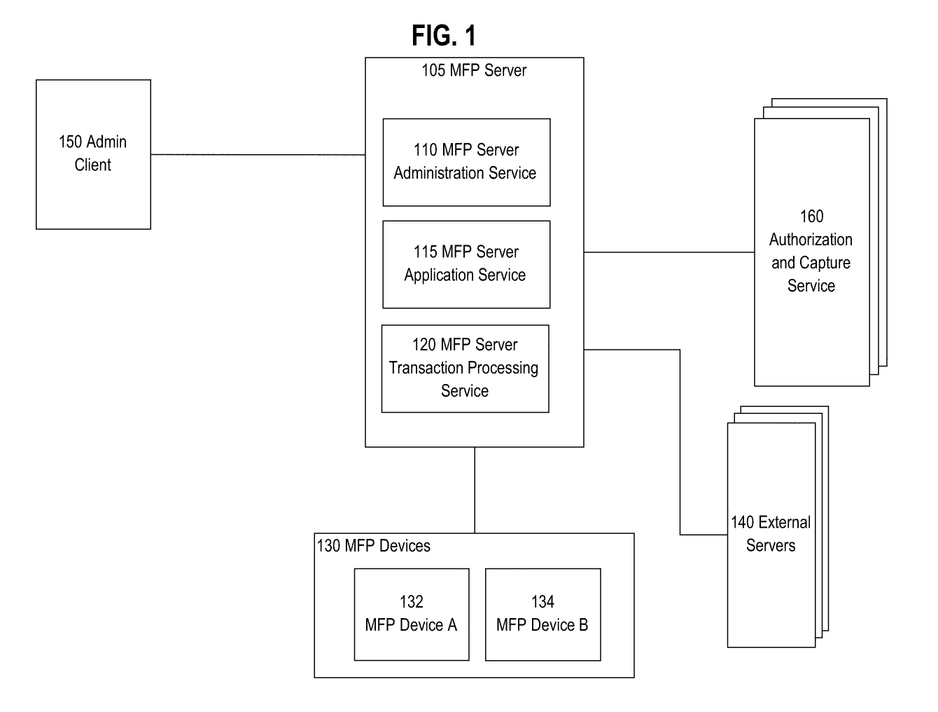

FIG. 1 is a diagram that depicts an arrangement for managing transaction processing errors related to services performed on multiple multi-function print (MFP) devices. FIG. 1 includes an admin client 150, an MFP server 105, MFP server administrative service 110, MFP server application service 115, MFP server transaction processing service 120, external servers 140, authorization and capture service 160, MFP devices 130, MFP device A 132, and MFP device B 134. The admin client 150, MFP server 105, MFP server administrative service 110, MFP server application service 115, MFP server transaction processing service 120, external servers 140, authorization and capture service 160, MFP devices 130, MFP device A 132, and MFP device B 134 may be communicatively coupled via one or more networks including, for example one or more wired or wireless networks, such as local area networks (LANs), wide area networks (WANs), the Internet, as well as one or more direct connections. In addition, although the elements of FIG. 1 are depicted and described herein in one particular configuration, this is done for explanation purposes only and the elements of FIG. 1 may be configured in any manner. For example, the MFP server 105 may represent two or more separate data servers, communicatively coupled via one or more networks, that each host and manage the MFP server administration service 110, the MFP server application service 115, and the MFP server transaction processing service 120 respectively. FIG. 1 is not limited the particular elements displayed and may include fewer or additional elements depending upon a particular implementation.

In an embodiment, admin client 150 may represent a computing device from which an admin may communicate with the MFP server 105 using a specific user account. Types of user accounts may include, but are not limited to, a vendor-administrator user account, a system administrator user account, or any other authorized user account. A vendor-administrator user account is a user account associated with a particular vendor that owns, leases, or manages different MFP devices. The vendor-administrator user account allows a specific vendor to manage different aspects of their MFP devices including, but not limited to, pricing for the available services, authorized customers of the MFP devices, configure payment services and payment routing, enabling and disabling different application services on the MFP devices, and adjusting the display order of available application services displayed on the MFP devices. The system administrator user account is a user account configured to grant system administrators access to manage different vendors, the application services available to the vendors, the list of linked MFP devices, and activity logs associated with specific vendors and/or specific MFP devices.

In an embodiment, admin client 150 may be configured to communicate requests to the MFP server 105. A request may be defined as either a request for information or a request to update configurations of vendor specific services and/or MFP specific configurations. In an embodiment, requests that specify requests for information may include, but are not limited to, a query for a current configuration of enabled application services, available applications, or any other query of user, MFP devices, or application services configured for a specific vendor or multiple vendors. In an embodiment, requests that specify configuration updates may include, but are not limited to, an update request to add, delete, or update: a list of vendors, customers, MFP devices, enabled application services, or categories of application service types. Categories of application service types may represent groups of application services that are grouped together based upon the type of service offered. For example, one category may represent enabled application services related to scanning documents, while another category may represent enabled application services related to making copies of documents, and yet another category may represent enabled application services related to printing documents. In an embodiment, types of categories may be modified, deleted, or new categories may be created.

In an embodiment, the MFP server 105 is configured to receive requests related to managing configurations of MFP devices 130, receive application requests originating from MFP devices 130, receive transaction requests from MFP devices 130, communicate application requests to external servers 140, and communicate transaction requests to authorization and capture services 160. FIG. 1 depicts an embodiment of the MFP server 105. The MFP server 105 is implemented using one or more computer programs or other software elements that are loaded into and executed using one or more general-purpose computers, or logic implemented in field programmable gate arrays (FPGAs) of application-specific integrated circuits (ASICs). The MFP server includes the MFP server administration service 110, the MFP server application service 115, and the MFP server transaction processing service 120.

In an embodiment, the MFP server administration service 110 is implemented using one or more programs executing on one or more computers within the MFP server 105. The MFP server administration service 110 is configured or programmed to receive a request from the admin client 150 and modify the application service configurations based on the request received. For example, if the request specifies adding application services to the set of enabled application services, then the MFP server administration service 110 is configured to generate a modified set of enabled application services that include the new application services specified in the user request. In another example, if the request specifies removing multiple MFP devices from the list of active MFP devices for a specific vendor user, then the MFP server administration service 110 is configured to generate a modified list of active MFP devices that does not include the MFP devices identified in the user request.

In an embodiment, MFP server administration service 110 is further configured or programmed to send the modified configurations to the target MFP devices. For example, if the received user request is a modification request for the currently enabled application services for a particular vendor user, then the MFP server administration service 110 modifies the currently enabled application services to generate a modified set of application services and then sends the modified set of application services to the MFP devices 130 associated with the particular vendor user. In an embodiment, the MFP server administration service 110 is configured to generate admin specific views for the admin client 150. Admin specific views may be used by administrators, such as a vendor-administrator, to view specific transactions and service tasks associated with the specific transactions.

In an embodiment, the MFP server application service 115 is implemented using one or more programs executing on one or more computers within the MFP server 105. The MFP server application service 115 is configured or programmed to receive application service requests, from an MFP device, format, and forward the received application service request to the external servers 140.

In an embodiment, the MFP server transaction processing service 120 is implemented using one or more programs executing on one or more computers within the MFP server 105. The MFP server transaction processing service 120 is configured or programmed to receive transaction requests, including but not limited to, transaction authorization requests and transaction capture requests, from a MFP device, create and/or update transaction records associated with the transaction requests, and send transaction requests to the authorization and capture service 160.

In an embodiment, transaction authorization requests may represent pre-authorization requests to authorize and reserve a specific charge amount on a user account for services to be performed on the MFP device by the user. For example, the transaction authorization request may be a pre-authorization request to authorize a $100 charge to a user's charge account for potential services that the user may perform during the user session on the MFP device. Transaction capture requests represent requests to charge a specified amount to the user's charge account, where the specified amount is based on the services performed during the user session on the MFP device. For example, if during the user session the user executed five different services on the MFP device, then the specified amount within the transaction capture request may be a summation of the amounts of each of the five executed services.

External servers 140 represents an example of multiple external application servers configured or programmed to receive and perform application specific requests. External servers 140 may implement multiple third party services including, but not limited to, hosted email services, Dropbox™, Box™, Google Drive™, Office 365™ application service, or any other externally managed application service. In an embodiment, the external servers 140 may be configured to communicate data such as result sets or acknowledgement messages to the MFP server 105 based on the type of application request. For example, if the application request is a scan and save into a specific Dropbox account, then the external Dropbox server may be configured to send an acknowledgement message indicating whether the document has been successfully saved in a customer's Dropbox folder to the MFP server 105. The MFP server 105 then may send the acknowledgement back to the specific MFP device so that the customer may be informed that the save to Dropbox was successful.

Authorization and capture service 160 represents an example of multiple different payment processing systems configured or programmed to receive transaction requests for a user and either authorize the request or capture a transaction to the user's account. The multiple payment processing systems represented by authorization and capture service 160 may include, but are not limited to, credit card transaction processing services, debit card transaction processing services, account transaction processing services, and any other processing service configured to authorize and capture transactions to a user account. For example, authorization and capture service 160 may include payment processing gateways such as Authorize.Net™ that manages routing of transactions to multiple different debit and charge services.

In an embodiment, the authorization and capture service 160 may be configured to communicate transaction authorization and capture acknowledgement messages to the MFP server 105 based on the type of transaction request. For example, if the transaction request is an authorization request authorizing one hundred dollars of services, then the authorization and capture service 160 may be configured to send an acknowledgement message indicating whether the authorization is granted to the MFP server 105. The MFP server 105 then may send the acknowledgement back to the specific MFP device allowing services up to the amount authorized.

FIG. 1 also depicts MFP devices 130, which represent different types of multi-function print devices including, but not limited to, small office or home office printers, larger commercial copy printers, portable multi-function print devices, or any other print device that is capable to communicating to the MFP server using a network connection. In an embodiment, the MFP devices 130 are equipped with a graphical user interface screen that allow a specific customer to enter commands and credential information that may be used to generate application service requests. In an embodiment, MFP device A 132 and MFP device B 134 each represent a specific MFP device associated with different vendor accounts.

### 3. MFP Device User Sessions

Users of the MFP devices 130 are able to use various services offered on the MFP devices 130. Services available on different MFP devices 130 may vary depending on the vendor associated with the specific service. For example, vendor-A may manage MFP device A 132 which offers services such as Dropbox and Box cloud storage, while vendor-B may manage MFP device B 134 which offers services such as Email and Microsoft Cloud Storage. In an embodiment, services used by users on MFP device A 132 and MFP device B 134 are managed by the MFP server 105. The MFP server 105 may be configured to track user sessions on MFP devices, such as MFP device A 132 and MFP device B 134.

In an embodiment, a user session is defined as a period of activity where a user may perform MFP device related services that may be charged as a single transaction to the user. One example of a user session is user activity on MFP device A 132 that occurs between when the user first logs into MFP device A 132 and when the user logs out of MFP device A 132. The start of a user session may be triggered when the user first swipes his credit card, debit card, student ID, or any other charge identifying device that may be used to identify the user and an associated charge account for which transactions may be charged against. In another example, a user session may be initiated by a user inputting his/her login credentials into MFP device A 132. For example, a user may create or have previously created an account on MFP device A 132. The user may initiate a new user session by logging into MFP device A 132 with his/her credentials.

In an embodiment, the MFP server transaction processing service 120 may record the beginning and ending of a user session for the purpose of tracking transaction status of user sessions. The MFP server transaction processing service 120 may implement one or more data structures within the MFP server 105 to store incoming user session activity. One such implementation of a data structure includes, but is not limited to, one or more database tables configured to contain user session information for each user session initiated on MFP devices 130.

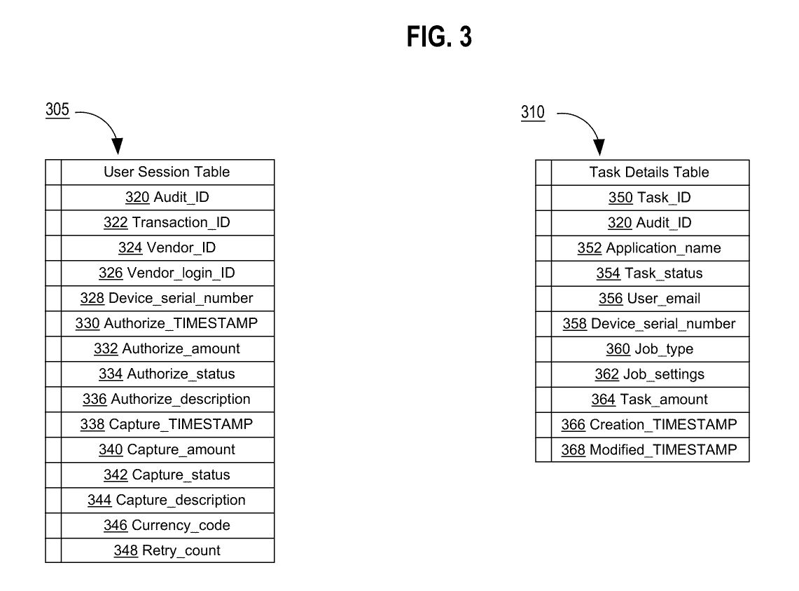

FIG. 3 depicts an example of database tables implemented by the MFP server 105 to manage and track user sessions from MFP devices 130. In an embodiment, user session table 305 represents a table used to track user sessions including transaction authorization requests and transaction capture requests. In an embodiment, audit_ID 320 may represent a unique identifier designated for each user session initiated on any one of the MFP devices 130. Transaction_ID 322 may represent a unique identifier associated with the authorization and capture service 160. For example, when either transaction authorization requests are sent to the authorization and capture service 160, the authorization and capture service 160 may respond with a unique identifier that may be used to identify the transaction within the authorization and capture service 160. In an embodiment, the user session table 305 may include vendor-administrator and MFP device information that may be used to identify the vendor and MFP device associated with the specific user session. For example, vendor_ID 324 and vendor_login_ID 326 may represent vendor identifiers used to associate a specific vendor to the user session. Device_serial_number 328 represents a unique MFP device identifier associated with a MFP device and may be used to store the MFP device identifier associated with each user session.

In an embodiment, user session table 305 may include one or more columns configured to store transaction authorization information associated with each of the user sessions. Authorize_TIMESTAMP 330 may represent an identifier used to record the latest timestamp associated with the latest update of transaction authorization information for a specific user session. Authorize_amount 332 may represent the transaction authorization dollar amount for the specific transaction authorization request. Authorize_status 334 may represent the current status of the authorization request for a specific user session. For example, if a transaction authorization request is received from the MFP device A 132, then the authorize_status 334 may be set to “pending”. If however, the MFP server transaction processing service 120 has received a successfully authorized message from the authorization and capture service 160, then the authorize_status 334 may be updated to “authorized”. In yet another example, if the authorization and capture service 160 rejects the authorization request then the authorize_status 334 may be set to “failed” or “denied”. In an embodiment, the authorization and capture service 160 may provide an authorization status description of whether an authorization request was accepted or denied. In an embodiment, authorization status descriptions for user sessions may be stored in authorize_description 336.

In an embodiment, user session table 305 may include one or more columns configured to store transaction capture information associated with each of the user sessions. Capture_TIMESTAMP 338 may represent an identifier used to record the latest timestamp associated with the latest update of transaction capture information for a specific user session. Capture_amount 340 may represent the transaction capture dollar amount for the specific transaction capture request. Capture_status 342 may represent the current status of the capture request for a specific user session. Capture_description 344 may store transaction capture status descriptions received from authorization and capture service 160. In an embodiment, the MFP server 105 may be configured to retry transaction capture requests and/or transaction authorization requests. Retry_count 348 may represent a retry count associated with requests sent from the MFP server 105 to the authorization and capture service 160. Currency_code 346 may represent a currency identifier that may be used to identify the currency used for the authorization and capture amounts.

In an embodiment, each user session may include one or more service tasks requested by the user. For example, a user may initiate a user session and during the user session the user may perform several different service tasks. Each of the service tasks may include services performed by the MFP device and one or more external servers 140. In an embodiment, the MFP server 105 may be configured to store information associated with each of the service tasks performed during a specific user session. One such example of the MFP server 105 storing service tasks, is the MFP server 105 storing service tasks in a task details table. Referring back to FIG. 3, task details table 310 may represent a database table configured to store information related to each of the service tasks performed during user sessions. In an embodiment, a unique task ID 350 may be assigned to each task stored within the task details table 310. The task details table 310 may also include a foreign key, audit_ID 320, which maps a specific user session stored in the user session table 305. In an embodiment, task specific details may be stored in the task details table 310 such as, application_name 352, user_email 356, device_serial_number 358, job_type 360, job_settings 362, task_amount 364, and task status 354. Task status 354 may include information related to the current status of a service task such as, whether it has been sent to the appropriate external servers 140, the task executed, or the task failed. The task details table 310 may also include a creation_TIMESTAMP 366 and modified_TIMESTAMP 368 columns that capture when the service task was created and the latest modified date for the service task.

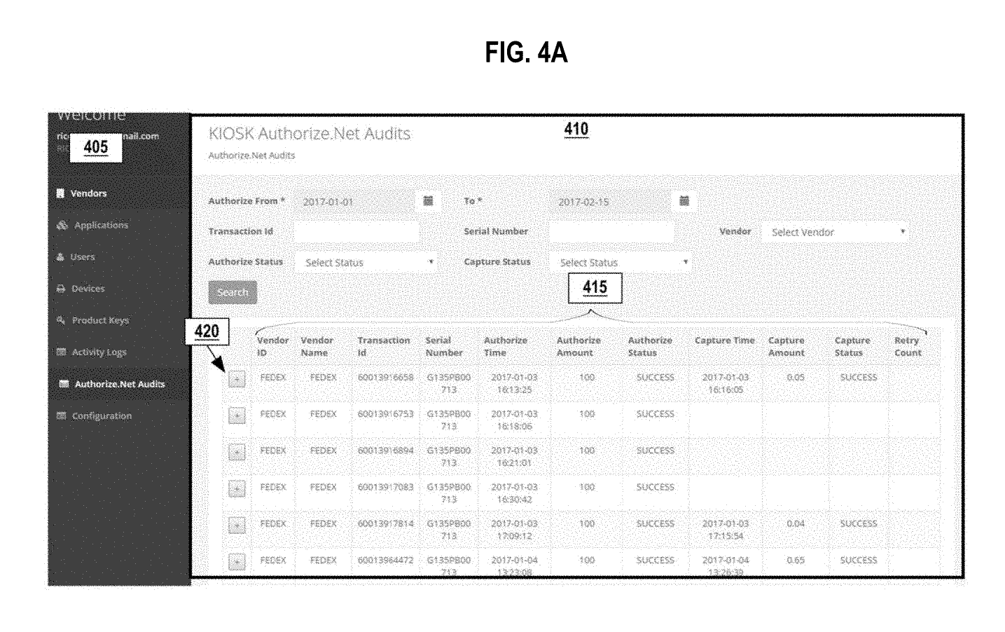

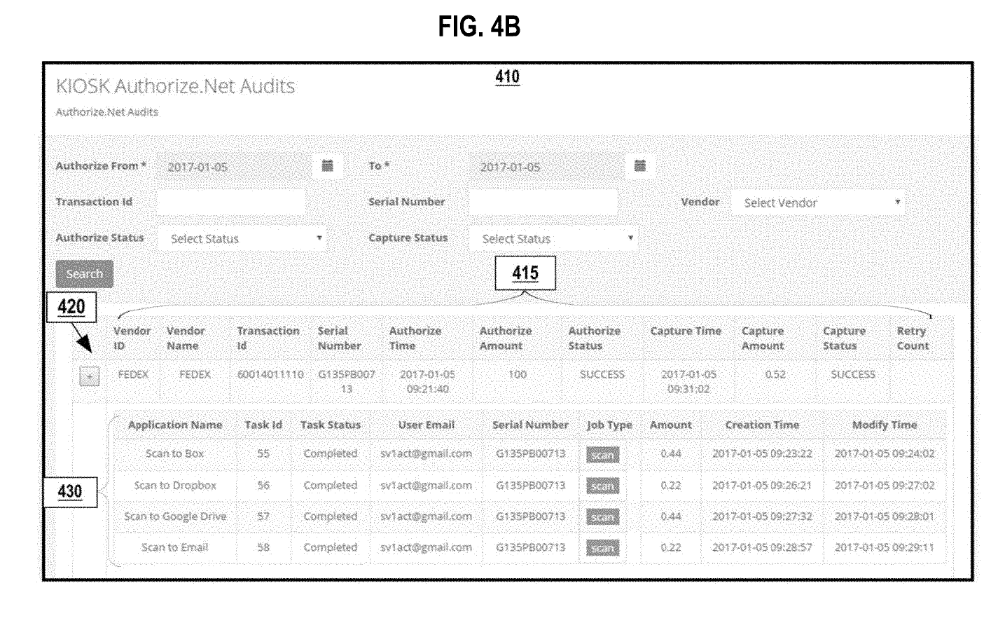

User session data and service task data may be viewable by vendor-administrators and system administrators. In an embodiment, the MFP server administration service 110 may be configured to display user session details specific to a vendor-administrator account. The MFP server administration service 110 may send to the admin client 150, user session details within a vendor application management screen. FIG. 4A depicts an example embodiment of a display screen displaying information related to multiple user sessions associated with a specific vendor-administrator account. In an embodiment, a display screen is communicatively coupled to admin client 150. In FIG. 4A, navigation pane 405 contains navigation links that allow the vendor-administrator to navigate between different configuration options including a user session audit screen that displays associated user sessions and user session status related to transaction authorization and transaction capture requests.

In an embodiment, vendor application management view 410 represents a vendor-administrator view that displays user sessions created by various users on MFP devices 130 associated with the specific vendor. In an embodiment, a list of user sessions may display user session display information 415 from the user session table 305 including, but not limited to, vendor_ID 324, vendor name, transaction_ID 322, device_serial_number 328, authorize_TIMESTAMP 330, authorize_amount 332, authorize_status 334, capture_TIMESTAMP 338, capture_amount 340, capture_status 342, and retry_count 348. In other embodiments, the user session display information 415 may be configured to display more or less user session information in the vendor application management view 410. The vendor application management view 410 allows vendor-administrators to view the current status of each user session including whether a specific user session was successfully authorized and whether transaction capture requests for each user session were successful.

In an embodiment, the vendor application management view 410 may be configured to allow vendor-administrators the option to display service task specific information for user sessions currently displayed. In an embodiment, a vendor-administrator may select the expand button 420, within the vendor application management view 410, to display the service task details associated with a specific user session.

FIG. 4B depicts an example embodiment of a display screen displaying service task information for a specific user session. In an embodiment, service tasks 430 display the multiple service tasks associated with the selected user session. The service tasks 430 displayed may be configured to display service task information from the task details table 310 including, but not limited to, application name, task_ID 350, task_status 354, user_email 356, device_serial_number 358, job_type 360, task_amount 364, creation_TIMESTAMP 366, and modify_TIMESTAMP 368. By displaying the task details for a specific user session, a vendor-administrator may be able to see the status of the individual service tasks as they relate to the total transaction capture request amount for a specific user session.

### 4. Transaction Processing Service

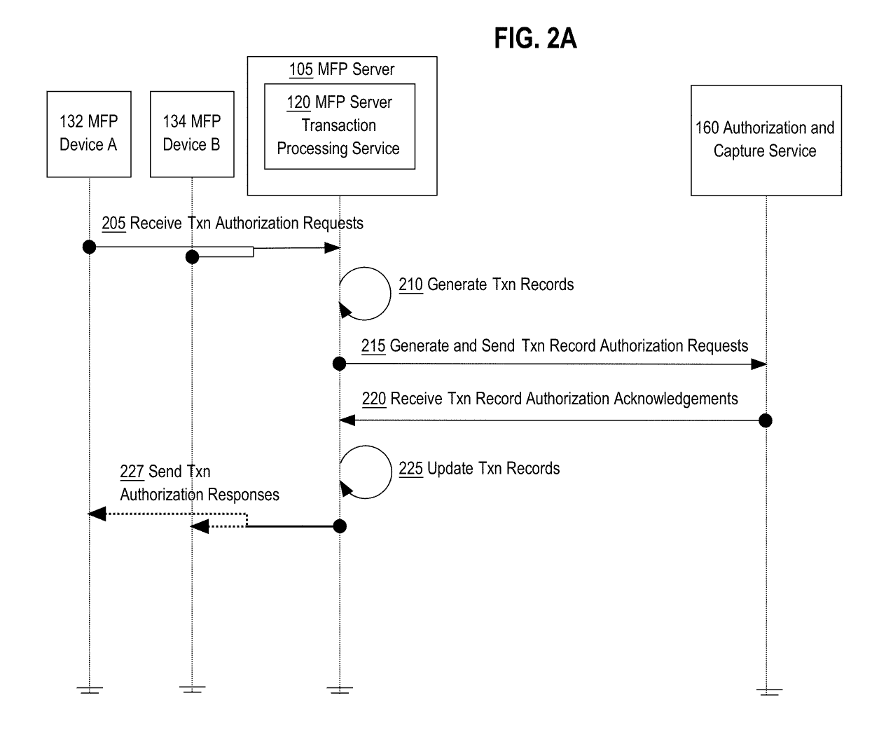

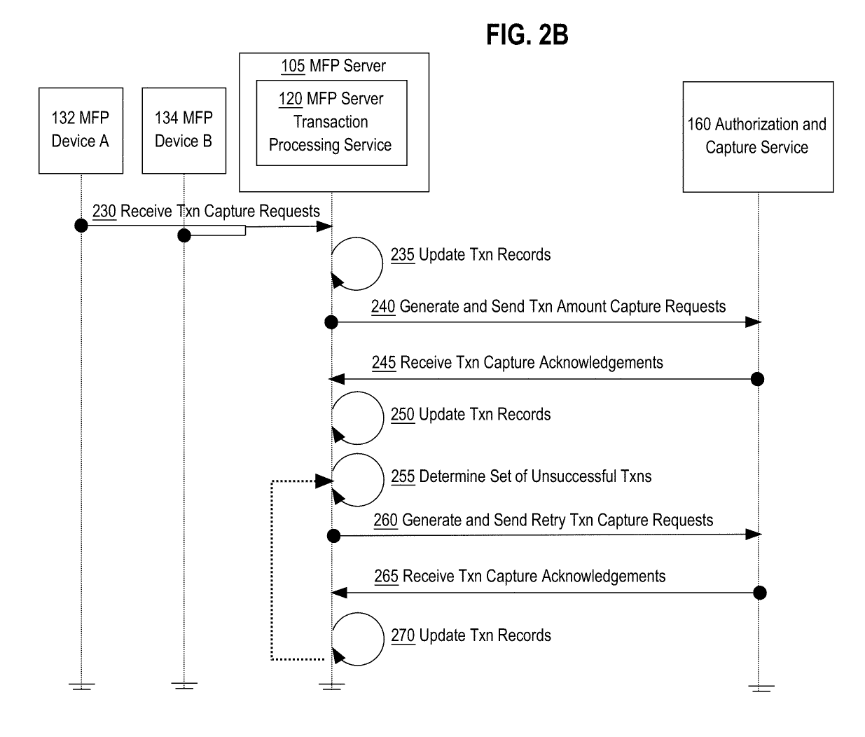

FIGS. 2A and 2B are flow diagrams that depict an example method for processing transaction requests from two or more MFP devices. FIGS. 2A and 2B contains multiple MFP devices represented by MFP device A 132 and MFP device B 134, MFP server transaction processing service 120, and the authorization and capture service 160. The MFP server transaction processing service 120 is depicted as implemented on MFP server 105. The various systems of FIGS. 2A and 2B may interact over a network shown in FIG. 1. Specifically, FIGS. 2A and 2B depict steps of receiving multiple different transaction requests, generating transaction records for multiple different transaction requests, sending multiple transaction requests to authorization and capture services, and determining whether a transaction request transmission failure occurred and if so, resending failed transaction requests to the authorization and capture service. In an embodiment, transaction requests may include, but are not limited to, transaction authorization requests and transaction capture requests.

### 4.1. Transaction Authorization Requests

Transaction authorization requests from MFP devices 130 are requests to pre-authorize a specified dollar amount that a user is authorized to spend on service tasks during the user session. Referring to FIG. 2A, step 205 depicts an embodiment of the MFP server transaction processing service 120 receiving two or more authorization requests from two or more MFP devices. In an embodiment, the MFP server transaction processing service 120 is configured to process transaction authorization requests from multiple different MFP devices 130 that may be managed by different vendors. For example, vendor-A may manage a first set of MFP devices including MFP device A 132 and vendor-B may manage a second set of MFP devices including MFP device B 134. The first set of MFP devices and the second set of MFP devices may represent sets of distinct devices located to distinct locations. For instance, vendor-A m ay represent a UPS vendor and the first set of MFP devices may include MFP devices located at UPS stores, while vendor-B may represent a FedEx vendor and the second set of MFP devices may include MFP devices located at FedEx stores.

In an embodiment, MFP device A 132 and MFP device B 134 each separately send transaction authorization requests to the MFP server transaction processing service 120. The transaction authorization request may include data that identifies the user from which authorization to charge services is requested, and information related to the vendor account that is requesting the charge authorization. In an embodiment, MFP devices, such as MFP device A 132 and MFP device B 134 collect user data when the user first interacts with the MFP device. For example, a user may initiate a user session by swiping a charge account card or by logging into the MFP device. The MFP device may capture the user's account information from his charge account card swiped or from information entered at the time of login.

Once a user session has been initiated, the MFP devices 130 may send a transaction authorization request to the MFP server transaction processing service 120. In an embodiment, the transaction authorization request may include information such as vendor ID, MFP device ID, user ID, user profile information, user charge information, and a timestamp for the authorization request. Vendor ID information represents information used to identify which vendor is requesting a service charge authorization. The transaction authorization request may also include MFP device identification information that may be used to identify the specific MFP device from which the request originates. User information included in the transaction authorization request may specify user personal information such as, name, phone number, address, student ID number or any other information collected by the MFP device. The user information may also include charge account information, such as credit card information or charge account information like a student deposit account.

Referring back to FIG. 2A, step 210 depicts the MFP server transaction processing service 120 generating transaction records for the received transaction authorization requests. In an embodiment, a transaction record may represent entries within an internal or external database or other data repository associated with the MFP server 105. For instance, the MFP server 105 may implement one or more database tables such as the user session table 305 and the task details table 310, as described in FIG. 3. In an embodiment, the MFP server transaction processing service 120 may insert new rows into the user session table 305 for each transaction authorization request received.

Referring back to FIG. 2A, step 215 depicts the MFP server transaction processing service 120 generating and sending transaction record authorization requests to the authorization and capture service 160. In an embodiment, the MFP server transaction processing service 120 may generate transaction record authorization requests from the newly created transaction records in the user session table 305 and any other vendor-related or user-related information. For example, a transaction record authorization request may include the vendor_ID 324, the authorize_amount 332, and user charge account information including user data that specifies the user, the user's charge account information, and any other user information needed to verify and authorize a user charge authorization on the user account. In an embodiment, transaction authorization requests generated by the MFP server transaction processing service 120 may be formatted according to one or more charge transaction protocols or any messaging protocol. For example, the transaction authorization request may be formatted using XML messages, JSON messages, or any financial transaction protocol.

In an embodiment, the MFP server transaction processing service 120 may be configured to send the generated transaction record authorization requests to the authorization and capture service 160 via the network. After sending the transaction record authorization requests to the authorization and capture service 160, the authorization and capture service 160 may process the requests to determine whether the users specified in the requests are pre-authorized for the requested charge amounts. For example, if the transaction record authorization requests include authorization requests for user-A and user-B on MFP device A 132 and MFP device B 134 respectively, then the authorization and capture service 160 determines if each of user-A and user-B are pre-authorized for the requested amount against their respective charge account specified in each authorization request. In multiple scenarios, the authorization and capture service 160 may determine that both user-A and user-B are pre-authorized, only one of user-A or user-B is pre-authorized, or neither user-A or user-B is pre-authorized for the requested charge amount. In an embodiment, the authorization and capture service 160 may determine pre-authorization by querying a user charge account information provided in the authorization request. In other embodiments, the authorization and capture service 160 may route authorization requests to the appropriate account service to determine whether the user is pre-authorized for the requested charge amount.

In an embodiment, the authorization and capture service 160 may generate a unique payment identifier that may be used to identify and track transaction authorizations and transaction captures for specific transactions within the authorization and capture service 160. For example, if the authorization and capture service 160 includes the Authorize.Net™ payment processing gateway, then the authorization and capture service 160 may assign a unique authorize.net transaction ID to each transaction request received. The authorize.net audit ID may be included in acknowledgement messages sent by the authorization and capture service 160 back to the MFP server transaction processing service 160.

Referring back to FIG. 2A, step 220 depicts receiving, from the authorization and capture service 160, transaction authorization acknowledgement messages corresponding to the transaction authorization requests sent at step 215. In an embodiment, the transaction authorization acknowledgement messages from the authorization and capture service 160 may include a unique authorize.net transaction ID, an authorization status value, a description of the authorization status which gives further detail as to whether authorization has been granted or denied, and any other authorization specific information from the authorization and capture service 160.

In an embodiment, the authorization status value within the transaction authorization requests may include values describing the state of the transaction request. Transaction states may include, but are not limited to, a success value and a failure value. The success value may represent the state where the transaction request for authorization was approved by the authorization and capture service 160. The failure value may represent the state where the transaction request for authorization was denied by the authorization and capture service 160. Example reasons for a failure value from the authorization and capture service 160 may include, but are not limited to, a denial of authorization based on insufficient funds in the user's charge account, the user is denied authorization because of an account hold, or a failure occurred within the authorization and capture service 160 during the authorization check.

In an embodiment, the transaction authorization acknowledgement messages may include a description associated with the authorization status. The description of the authorization status may be configured to include description information associated with the authorization status value. For example, if the authorization status value indicates a failed authorization, then the description field may indicate that the failure was based upon the user having insufficient funds, the user information is incorrect, or any other reason that may cause an authorization failure.

At step 225, the MFP server transaction processing service 120, updates records corresponding to the transaction authorization acknowledgement messages received at step 220. In an embodiment, the MFP server transaction processing service 120 updates the records stored within the user sessions table 305. For example, the transaction_ID 322 field may be populated with an authorize.net transaction ID provided by the authorization and capture service 160. The authorize_status 334 and authorize_description 336 field may also be updated with information from the transaction authorization acknowledgement message. In an embodiment, the authorization and capture service 160 may authorize the transaction at a lower authorization amount than specified in the transaction record authorization request. For example, the transaction record authorization request sent by the MFP server transaction processing service 120 may include a request to authorize $100 for the specific user. However, the authorization and capture service 160 may only allow $50 for the specific user. The authorization and capture service 160 may sent a transaction authorization acknowledgement message with is a success status for authorization but specify that only $50 is authorized and not the requested $100. In this scenario, the MFP server transaction processing service 120 may be configured to further update the authorize_amount 332 field within the user session table 305 to reflect the amount authorized by the authorization and capture service 160.

Optionally, the MFP server transaction processing service 120 may be configured to send transaction authorization responses to the MFP device A 132 and MFP device B 134. Step 227 in FIG. 2A depicts the optional step of sending transaction authorization responses to the MFP device A 132 and MFP device B 134. By sending transaction authorization responses to the MFP device A 132 and MFP device B 134, the MFP server transaction processing service 120 is able to notify the corresponding MFP device A 132 and MFP device B 134 that the user is authorized to perform service task or is not authorized to perform service tasks. In another embodiment, each of the MFP device A 132 and MFP device B 134 may be configured to query the MFP server 105 to determine whether authorization was granted prior to allowing service tasks to be performed.

### 4.2. Transaction Capture Requests

Transaction capture requests represent requests to charge a specific amount to the user's charge account based on the service tasks performed during the user session. Transaction capture requests are therefore generated after the user has performed the desired service tasks on the MFP device.

In an embodiment, after a user using a specific MFP device is authorized to perform service tasks, the user may begin performing tasks on the specific MFP device. For example, if a user is using MFP device A 132 and has been authorized to perform service tasks up to $100, then the user may perform any MFP device related service tasks available on MFP device A 132 such as scan to Dropbox, scan to Box, scan and email, make photocopies of documents, and any other task service available.

After performing the desired service tasks, MFP device A 132 may be configured to generate a transaction capture request which summarizes the charge amount for the service tasks performed by the user during the user session. In an embodiment, the MFP device A 132 determines that the user has completed the desired service tasks when the user logs out of the MFP device A 132. In another embodiment, the MFP device A 132 may be configured with graphical user interface instructions that allow the user to specify that he has completed the desired service tasks and a transaction capture request should be generated.

In an embodiment, the transaction capture request may include data specifying the user session, the user, the vendor account, the MFP device, and the transaction capture amount that may be a summary of the service tasks performed. For example, if the user of MFP device A 132 performed service tasks X, Y, Z each costing $10, then the generated transaction capture request may include a transaction capture amount of $30, which is the sum of service tasks X, Y, and Z. In other embodiments, the transaction capture request may include more information, such as an itemized list of all service tasks performed.

Referring to FIG. 2B, step 230 depicts receiving transaction capture requests from MFP device A 132 and MFP device B 134. In an embodiment, the transaction capture requests received may include multiple transaction capture requests from different MFP devices managed by different vendor accounts.

At step 235, the MFP server transaction processing service 120 updates transaction records, corresponding to the received transaction capture requests, with the requested transaction capture amount. In an embodiment, the MFP server transaction processing service 120 updates the transaction records in the user session table 305 that correspond to the received transaction capture requests with the requested transaction capture amount. For example, if at step 230 transaction capture requests are received for transaction records X and Y, then at step 235 the MFP server transaction processing service 120 updates transaction records X and Y by setting the capture_amount 340 to the values specified in the received transaction capture requests. In an embodiment, updating the transaction records may also include setting the capture_status 342 field to pending, setting the capture_TIMESTAMP 338 to the time the transaction capture requests were received, and setting the retry_count 348 to zero, where zero represents that the capture request has not yet been sent to the authorization and capture service 160.

At step 240, the MFP server transaction processing service 120 generates transaction amount capture requests corresponding to the transaction capture requests received at step 230, and sends the generated transaction amount capture requests to the authorization and capture service 160. For example, if at step 230 transaction capture requests were received from MFP device A 132 and MFP device B 134, then two transaction amount capture requests would be generated. In an embodiment, the transaction amount capture requests contain data including, but not limited to, the transaction_ID 322, the capture_amount 340, the capture_TIMESTAMP 338, and any other data related to the transaction.

In an embodiment, the MFP server transaction processing service 120 sends the generated transaction amount capture requests to the authorization and capture service 160 for the purpose of deducting the capture amount from the user's charge account. For example, if the transaction amount capture request specified a capture amount of $30 for a specific user, then the authorization and capture service 160 may use the transaction amount capture request as a request to charge the specific user $30 on the associated charge account. In an embodiment, upon charging the capture amount to the user's charge account, the authorization and capture service 160 may be configured to send back to the MFP server transaction processing service 120 a capture acknowledgement message that specifies that either: the capture request was received and successfully charged to the user account, the capture request was received and unsuccessfully charged to the user account, or that the capture request was received and not yet charged to the user account.

At step 245, the MFP server transaction processing service 120 receives, from the authorization and capture service 160, transaction capture acknowledgements. In an embodiment, the transaction capture acknowledgements include data specifying whether the transaction capture was successful or unsuccessful and any other details related to the capture. For example, if the transaction capture acknowledgement specifies that the capture was unsuccessful then the transaction capture acknowledgements may include data indicating the reason for the unsuccessful capture.

At step 250, the MFP server transaction processing service 120 updates the transaction records to reflect the data within the received transaction capture acknowledgements. In an embodiment, the MFP server transaction processing service 120 is configured to update the transaction records within the user session table 305 by updating the capture_status 342 field with a successful, unsuccessful, or still pending status. In an embodiment, if the transaction capture acknowledgement specified that the capture was successful, then the MFP server transaction processing service 120 would update the capture_status 342 field to “success”. If the transaction capture acknowledgement specified that the capture was unsuccessful, then the MFP server transaction processing service 120 would update the capture_status 342 field to “retry” and if a reason for the failure was included in the transaction capture acknowledgement the MFP server transaction processing service 120 would update the capture_description 344 field to the reason for the failure. The MFP server transaction processing service 120 may be configured with a max retry value that caps the number of transaction capture attempts that may be requested for a particular transaction record. If a transaction record retry_count 348 field reaches the max number of attempts then the MFP server transaction processing service 120 may be configured to stop retrying and update the capture_status 342 field to “failed.”

In an embodiment, the transaction capture status within the transaction capture acknowledgement may specify that the authorization and capture service 160 is still processing the request. This may occur if the authorization and capture service 160 communicates with another account service to charge the capture amount but, the other account service has not yet acknowledged whether the capture was successful or unsuccessful. In this scenario, the authorization and capture service 160 may send an acknowledgement back to the MFP server transaction processing service 120 to indicate that the request was received and is still being processed. The MFP server transaction processing service 120 may then update the capture_status 342 field to “pending.” This type of acknowledgement may be useful in preventing the MFP server transaction processing service 120 from sending unnecessary retry capture requests.

In an embodiment, if after a specified period of time the MFP server transaction processing service 120 does not receive any transaction acknowledgements from the authorization and capture service 160, then MFP server transaction processing service 120 may be configured to update the capture_status 342 for transaction records where no transaction acknowledgements was received to “retry”, populate the capture_description 344 field to indicate that no acknowledgement was received from the authorization and capture service 160.

### 4.3. Reconciling Failed Capture Requests

In an embodiment, the MFP server transaction processing service 120 may be configured to reconcile unsuccessful transaction capture requests by determining which transaction records were unsuccessful and generating new transaction capture requests. Referring back to FIG. 2B at step 255, the MFP server transaction processing service 120 determines a set of unsuccessful transaction capture records that may need to be resent to the authorization and capture service 160. In an embodiment, the MFP server transaction processing service 120 analyzes the user session table 305 to determine one or more transaction records that qualify for a retry transaction capture request. For example, the MFP server transaction processing service 120 may be configured to iterate through the transaction records in the user session table 305 to identify transaction records with the capture_status 342 field set to “retry” and the retry_count 348 field having a value that is less than the configured maximum retry amount. After identifying a subset of transaction records with the capture_status 342 field set to “retry”, the MFP server transaction processing service 120 may be configured to generate retry transaction amount capture requests for the subset of transaction records.

At step 260, the MFP server transaction processing service 120 generates and sends retry transaction amount capture requests for the subset of transaction records identified in step 255. In an embodiment, the MFP server transaction processing service 120 may generate retry transaction amount capture requests that contain data including, but not limited to, the transaction_ID 322, the capture_amount 340, the capture_TIMESTAMP 338, and any other data related to the transaction. In an embodiment, the content and format of the retry transaction amount capture requests may be the same as the transaction capture requests generated and sent by the MFP server transaction processing service 120 at step 240.

In an embodiment, the MFP server transaction processing service 120 may be configured to additionally increment the retry_count 348 field by one when a retry transaction amount capture request is generated for a particular transaction record.

After generating the retry transaction amount capture requests, the MFP server transaction processing service 120 is configured to send the retry transaction amount capture requests to the authorization and capture service 160 via the network. The authorization and capture service 160 may process the retry transaction amount capture requests by charging the capture amount specified in the request to the user's charge account. Upon attempting to charge the user's charge account, the authorization and capture service 160 may send capture acknowledgement messages back to the MFP server transaction processing service 120. The capture acknowledgement messages may specify either: the capture request was received and successfully charged to the user account, the capture request was received and unsuccessfully charged to the user account, or that the capture request was received and not yet charged to the user account.

At step 265, the MFP server transaction processing service 120 receives, from the authorization and capture service 160, transaction capture acknowledgements corresponding to the retry transaction amount capture requests sent at step 260. In an embodiment, the transaction capture acknowledgements include data specifying whether the transaction capture was successful or unsuccessful and any other details related to the capture.

At step 270, the MFP server transaction processing service 120 updates the transaction records to reflect the data within the received transaction capture acknowledgements. In an embodiment, the MFP server transaction processing service 120 is configured to update the transaction records within the user session table 305 by updating the capture_status 342 field with a status that specifies whether the transaction capture was successful, unsuccessful, or still pending. In an embodiment, if the transaction status is “successful”, then the MFP server transaction processing service 120 updates the capture_status 342 field to reflect the successful transaction capture of funds from the user's charge account for service tasks performed. If however, the transaction status is “unsuccessful”, then the MFP server transaction processing service 120 updates the capture_status 342 field to reflect the unsuccessful transaction capture attempt.

In an embodiment, the MFP server transaction processing service 120 may be configured to repeat the retry capture steps for unsuccessful transaction records by determining whether any transaction records within the user session table 305 have an unsuccessful capture_status 342. Referring back to FIG. 2B, repeating the retry capture steps for unsuccessful transaction records is represented by the dotted arrow from step 270 back to step 255. At step 255 the MFP server transaction processing service 120 determines whether any transaction records have an unsuccessful capture status. In an embodiment, MFP server transaction processing service 120 may be configured to perform the determination step 255 after updating transaction record status in response to receiving transaction capture acknowledgements. In another embodiment, the MFP server transaction processing service 120 may be configured to periodically perform the determination step 255 to check if any transaction records require a retry transaction capture request.

### 5. Service task Reconciliation

As described previously, when a user logs into a MFP device, the MFP device requests a transaction authorization for the user from the MFP server 105 and the authorization and capture service 160. Once authorized, the user of the MFP device may perform various service tasks during a single user session. Upon completion of the user session, the MFP device may request a transaction capture to capture from the user's charge account an amount that equals the total sum of all services requested and/or performed. However, some service task requests may require performing tasks on external third-party servers. For example, if the user requests a scan and save to a Dropbox folder, then the scan part of the task may be performed by the MFP device but, the save to Dropbox task may require external Dropbox servers and services to receive and save the file to the appropriate remote directory within the Dropbox cloud. These third-party steps may, in some cases, be performed after the user has ended the user session on the MFP device. If however, the Dropbox service fails to save the file in the appropriate Dropbox folder, then the user may be entitled to a refund for services that were unsuccessful. In an embodiment, the MFP server application service 115 and the MFP server transaction processing service 120 may be configured to manage the multiple service tasks performed during a specific user session and if one or more service tasks fails, the MFP server transaction processing service 120 may be configured to determine a refund value for the one or more service task failures and generate a refund request that may be sent to the authorization and capture service 160.

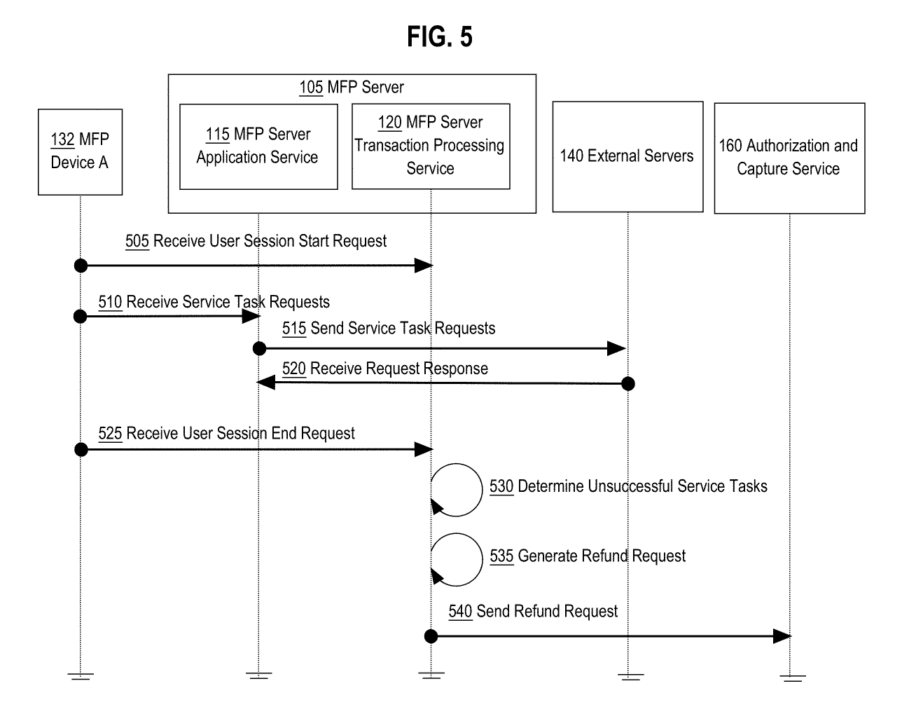

FIG. 5 is a flow diagram that depicts an example method for managing service task requests for a particular user session from an MFP device and determining and generating a refund request for unsuccessful service requests during the user session. FIG. 5 contains MFP device A 132, MFP server application service 115, MFP server transaction processing service 120, external servers 140, and the authorization and capture service 160. The MFP server application service 115 and MFP server transaction processing service 120 are depicted as implemented on MFP server 105. The various systems of FIG. 5 may interact over a network shown in FIG. 1. Specifically, FIG. 5 depicts steps of receiving multiple service task requests, sending the multiple service task requests to external servers 140, determining whether a service task was not successfully completed by the external servers 140 and if so, generating and sending a refund request to refund the amount for all service tasks not successfully completed.

### 5.1. tracking Service tasks Requested in a User Session

At step 505 the MFP server transaction processing service 120 receives a request to start a user session. In an embodiment, a request to start a user session is generated and sent by MFP device A 132 when a user logs into MFP device A 132. As described previously, a user session on an MFP device may be initiated when a user swipes a charge account card or logs into the particular MFP device. The MFP device A 132 may then send a transaction authorization request in order to pre-authorize the user. In an embodiment, the transaction authorization request represents a request to start a user session. When the MFP server transaction processing service 120 receives the transaction authorization request, the MFP server transaction processing service 120 generates a transaction record in the user session table 305. The start of a user session may begin once a transaction record has been created in the user session table 305.

At step 510, the MFP server application service 115 receives one or more service task requests from the MFP device A 132 corresponding to the user session start request received at step 305. During the user session, the user may perform several different service tasks. For each service task initiated the MFP device A 132 may be configured to generate a specifically formatted service task request that specifies request parameters including, but not limited to, customer account information, application service information, document data, and other data that specifies application service configuration that may be related to the specific vendor, the specific MFP device A 132 used, and/or the specific customer using the MFP device A 132. An example of a server request from a MFP device A 132 is a scan and save request from a customer that scanned a document on the MFP device A 132 and is requesting to save the scanned document in a folder within their Dropbox account.

In an embodiment, customer account information may include information related to the specific customer and the application service used by the customer, such as the customer's login credentials for specific application services such as Google Drive, Dropbox, Email, or any other enabled application service.

In an embodiment, application service information enclosed in the service request may include data that specifies the specific application service requested. For example, if the specific customer initiates a scan and intends to save the scanned document in Dropbox, then the application service information, within the service request, may specify information identifying the Dropbox application and specific requested actions for the Dropbox application. In an embodiment, the application service information may be formatted in a standardized format where defined parameters are used to identify the application service used on the MFP device 130.

In an embodiment, document data may include the data processed by the MFP device A 132 itself. For example, if the customer performs a scan on the MFP device A 132, then the document data may include the digital image of the document scan and any other metadata generated during the scan of the document.

At step 515, the MFP server application service 115 formats the one or more service task requests and sends the service task request to the appropriate endpoint associated with the application service identified within the service task request. Using the previous example, if the service task request specified saving a scanned document in a Dropbox folder of the particular customer, then the MFP server application service 115 would determine from the data within the service task request the specified application service as Dropbox and the login credentials associated to the specific customer. In an embodiment, the MFP server application service 115 formats the data within the service task request to conform with input message parameters specific to the endpoint. For example, if the MFP server application service 115 determines that the service task request message is a scan and save to the customer's specific Dropbox folder, then the MFP server application service 115 may format the request to conform to defined API call request parameters for the Dropbox endpoint.

In an embodiment, formatting the service task request to conform to defined API call request parameters may include different format configurations specific to the endpoint destination. For example, formatting service task requests for Google Drive may by different from the formatting required for Dropbox, or any other enabled application. In an embodiment formatting for each specific application service endpoint may use different parameters from the service request. For instance, the email service endpoint may only require a customer's email address and email credentials, while a Dropbox service endpoint may require the customer's Dropbox credentials, and a specific destination folder within the customer's account.

In an embodiment, the MFP server application service 115 may be further configured to store the service task request data in the MFP server 105 for the purpose of tracking and maintaining a record of the requested service tasks. For example, data from the service task request may be stored in one or more database tables, such as the user session table 305, the task details table 310, and any other database table configured to store vendor and/or user information. In an embodiment, the MFP server application service 115 may be configured to generate a new task record in the task details table 310 for each service task request received. The new task record may include, but is not limited to: generating a unique task identifier in the task_ID 350 field; storing a foreign key represented by audit_ID 320 that links the service task to the specific user session from which the task was requested; storing the application service requested in the application_name 352 field, storing an initial task status in the task_status 354 field; storing the user's contact information in the user_email 356 field; storing a MFP device identifier in the device_serial_number 358 field; storing service task specific parameters in fields job_type 360 and job_settings 362; storing the calculated cost of performing the service task in the task_amount 364 field; and storing timestamps for when the task record was created and modified in the creation_TIMESTAMP 366 and modified_TIMESTAMP 368 fields. In other embodiments the task record may contain other data fields storing and/or linking to additional MFP device and vendor specific information that may be used to track and manage the service tasks requested. In an embodiment, the MFP server application service 115 may be configured to calculate and store the task_amount 364 based on job specific data such as job_type 360 and job_settings 362. For example, the job_type 360 and job_settings 364 may include details such as the number of pages scanned and the resolution associated with the scan. The job specific details may then be used to calculate a charge amount for the specific service task. In other embodiments, the charge amount for the specific task may be provided by the MFP device A 132 and may be stored in the task_amount 364 field.

Referring back to FIG. 5, step 520 depicts the MFP server application service 115 receiving response messages back from the external servers 140. In an embodiment, the endpoint application service on the external servers 140 is configured to send a response message back to the MFP server application service 115. Examples of response messages may include, but are not limited to, an acknowledgement message, a result set of a list of files within the destination folder, or any other message to indicate that the request has been executed. Additionally, the endpoint application service on the external servers 140 may send a response message indicating that the service task failed. Examples reason for a failure may include, but are not limited to, a communication error within the external servers 140, a technical service outage, a denial user credentials provided, or any other configuration or technical error.

In an embodiment, upon receiving response messages from the external servers 140, the MFP server application service 115 is configured to update corresponding task records in the task details table 310. For example, if a response message indicates that the service task was completed, then the task_status 354 field in the corresponding task record may be updated to reflect the completion of the task. In another example, if the service task failed, or otherwise was not completed, then the MFP server application service 115 may update the task_status 354 field to indicate a failure. In another embodiment, if a response message indicates that the service task request failed, then the MFP server application service 115 may be configured to send a retry service task request to the external servers 140 if the failure is a result of a temporary error. If a retry request is made, then the MFP server application service 115 may update the task_status 354 field to indicate a retry attempt. The MFP server application service 115 may be configured to attempt a specific number of retries before concluding that the service task request has failed. For example, if the response request indicates that the external servers 140 are partially down, then the MFP server application service 115 may update the task_status 354 field to retry and may send a retry request after a specific period of time. If however, the response request indicates that the service task request failed because the user credentials are invalid, then the MFP server application service 115 may be configured to update the task_status 354 field to failed.

In an embodiment, external servers 140 may send response messages described at step 520 at any time after receiving the service task request. For example, the external servers 140, which receive a service task request to save a document in a specific Dropbox folder, may not send a response message back to the MFP server application service 115 until after the user session has been completed and the user has logged off the MFP device A 132. In this scenario, the MFP server application service 115 would receive the response from the external servers 140 and update the corresponding task record in the task details table 310.

### 5.2. Reconciling Failed Service Tasks from User Sessions

In an embodiment, the MFP server transaction processing service 120 may be configured to determine service task requests that failed or otherwise were not completed by the external servers 140. The failed service transaction requests may then be reconciled in order to generate a refund request from service task not successfully completed.

Referring back to FIG. 5, at step 525 the MFP server transaction processing service 120 receives an end user session request from the MFP device A 132. In an embodiment, an end user session request may be a transaction capture request and may be triggered when the user logs out of the MFP device A 132. In response to receiving the end user session request, the MFP server transaction processing service 120 may update the corresponding transaction records in the user session table 305 to indicate that the user's session has ended. As described above, the MFP server processing service 120 may generate a transaction capture request to request a charge to the user charge account for an amount equal to the sum of all service tasks requested during the user session. Since service task request may have not yet been completed, the transaction capture request may charge the user account for services requested but not yet completed. If the external servers 140 fail to complete one or more services tasks, the user may be entitled to a refund for service tasks that were not successfully completed.

At step 530, the MFP server transaction processing service 120 may be configured to determine whether one or more service tasks have not been successfully completed. In an embodiment, the MFP server transaction processing service 120 may be configured to generate a set of failed service tasks that represent a subset of service tasks that were not successfully completed. In an embodiment, the set of failed service tasks may include only service tasks from user sessions that have been completed. Service tasks from user sessions that are still active may not be used to generate refund requests against still active user sessions because the user sessions have not yet generated a transaction capture request and therefore cannot be eligible for a refund since no charges have been made.

In an embodiment, the MFP server transaction processing service 120 may be configured to generate the set of failed service tasks by first determining a set of completed user sessions. The MFP server transaction processing service 120 may determine the set of completed user sessions by analyzing the user sessions table 305 for transaction records that have a non-null capture_TIMESTAMP 338 value. If the capture_TIMESTAMP 338 field has a non-null value for a particular transaction record, then that means that the MFP server transaction processing service 120 has received, from the MFP device A 132, a transaction capture request. Since transaction capture requests are only sent after a user session is complete, the MFP server transaction processing service 120 may determine that transaction records that have a non-null value from the capture_TIMESTAMP 338 field have completed user sessions. The set of completed user sessions may include unique identifiers, such as audit_ID 320, to identify the transaction records for completed user sessions. In other embodiments, the MFP server transaction processing service 120 may use different fields in the user sessions table 305, such as capture_status 342, to determine whether a user session for a particular transaction record has been completed.

In an embodiment, the MFP server transaction processing service 120 may use the set of completed user sessions to query the task details table 310 for failed service tasks associated with the set of completed user sessions. For example, the MFP server transaction processing service 120 may generate a database query to search for task records within the task details table 310 that have a task_status 354 value set to failed and have an audit_ID 320 value equal to one of the audit_ID 354 values in the set of completed user sessions.

In an embodiment, the set of failed task records may also include task records for service task requests that never received a request response from the external servers 140. For example, if a particular task record in the task details table 310 indicates that a specific period of time has passed since sending the service task request and no request response was received, then this may indicate an error occurred at the external servers 140 and no response was sent back to the MFP server transaction processing service 120. The MFP server transaction processing service 120 may be configured to determine failed service tasks based on a non-response from the external servers 140 by searching for task records that have a task_status 354 value set to “sent” and the modified_TIMESTAMP 368 containing a timestamp that indicates a significant duration of time has passed since the initial service task request was sent. The MFP server transaction processing service 120 may be configured with a timeout threshold that represents a duration of time which, when exceeded indicates that an error on the external server 140 may be the reason for the non-response from the external server 140.

Referring back to FIG. 5, step 535 depicts a step of generating, from the set of failed task records, refund requests that represent a request for a refund for an amount equal to the failed service tasks originally charged in the transaction capture request. In an embodiment, the MFP server transaction processing service 120 may be configured to aggregate the values from the set of failed task records for a specific user session in order to calculate a total refund value to be refunded to the user's charge account. The total refund value may represent the value to be refunded for failed service tasks, where the failed service tasks may have been requests to multiple different endpoints each representing a different third party service.

The MFP server transaction processing service 120 may be configured to generate multiple refund requests, one refund request for each user session identified, from the set of failed service tasks, where failed task records in the set of failed task records are grouped by audit_ID 320. For example, if the set of failed service tasks includes 10 failed service tasks originating from two different user sessions, then the failed service tasks may be grouped into two groups based on the matching audit_IDs for each user session. By doing so the MFP server transaction processing service 120 conserves processing resources by only generating one refund request for each user session, rather than generating multiple refund requests for each individual failed service task within a single user session.

In an embodiment, the MFP server transaction processing service 120 may be configured to generate refund requests for each user session containing the calculated total amount to be refunded, the audit_ID 320, the transaction_ID 322, user information such as user charge account, vendor information, and any other information needed to refund the total amount back to the user's charge account associated with the specific user session.

At step 540, the refund requests are sent to the authorization and capture service 160. In an embodiment, the MFP server transaction processing service 120 may be configured to send the refund requests to the authorization and capture service 160 for processing. In an embodiment, the MFP server transaction processing service 120 may be configured to send notifications to the admin client 150 in order to notify the specific vendor-administrators associated within the refund requests. Additionally the MFP server transaction processing service 120 may be configured to send notifications to the user associated with the refund request in order to inform the user that a refund request has been sent for service tasks that were not successfully completed.

In an embodiment, the authorization and capture service 160 may refund the amount requested to the user charge account associated with the transaction capture request and send an acknowledgement back to the MFP server transaction processing service 120 indicating that the refund was successfully completed. The MFP server transaction processing service 120 may then update the task details table 310 to indicate that the failed service tasks have been refunded. In an embodiment, a vendor-administrator may be able to check the status of refund requests using the admin client 150. In an embodiment, the MFP server transaction processing service 120 may be configured to notify the vendor-administrator that the refund was successfully completed and is reflected in the task details table 310.

### 6. Implementation Mechanisms

Although the flow diagrams of the present application depict a particular set of steps in a particular order, other implementations may use fewer or more steps, in the same or different order, than those depicted in the figures.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

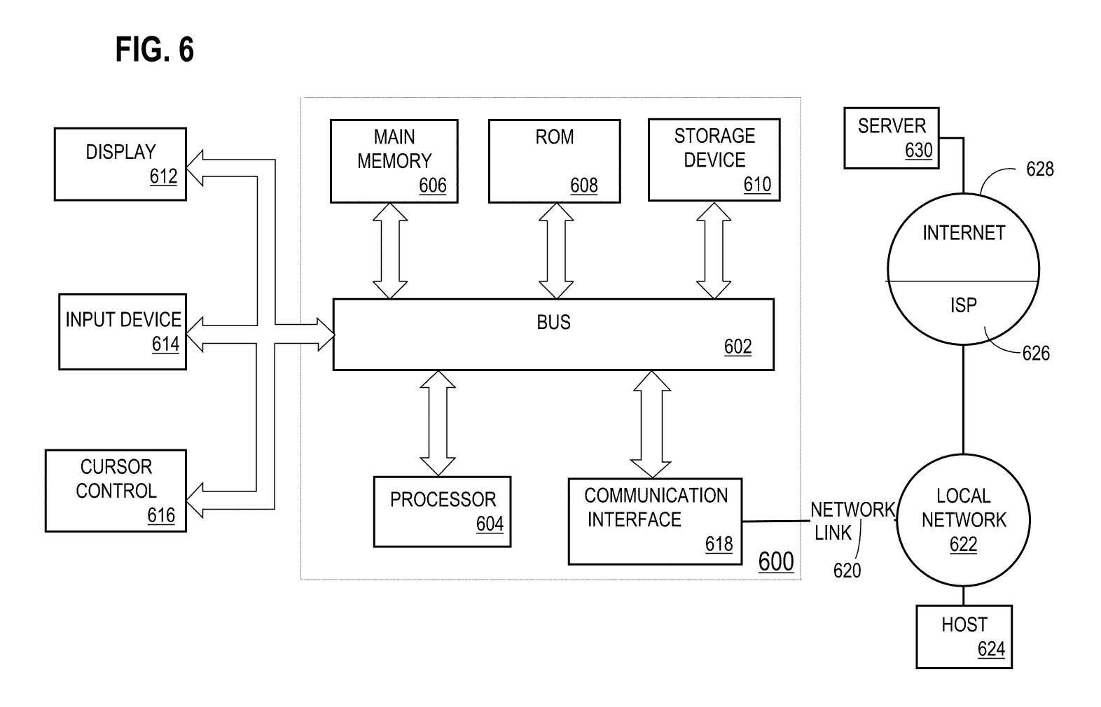

FIG. 6 is a flow diagram that depicts an example computer system 600 upon which embodiments may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. Although bus 602 is illustrated as a single bus, bus 602 may comprise one or more buses. For example, bus 602 may include without limitation a control bus by which processor 604 controls other devices within computer system 600, an address bus by which processor 604 specifies memory locations of instructions for execution, or any other type of bus for transferring data or signals between components of computer system 600.

An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic or computer software which, in combination with the computer system, causes or programs computer system 600 to be a special-purpose machine. According to one embodiment, those techniques are performed by computer system 600 in response to processor 604 processing instructions stored in main memory 606. Such instructions may be read into main memory 606 from another non-transitory computer-readable medium, such as storage device 610. Processing of the instructions contained in main memory 606 by processor 604 causes performance of the functionality described herein. In alternative embodiments, hard-wired circuitry may be used in place of or in combination with software instructions to implement the embodiments. Thus, embodiments are not limited to any specific combination of hardware circuitry and software.

The term “non-transitory computer-readable medium” as used herein refers to any non-transitory medium that participates in providing data that causes a computer to operate in a specific manner. In an embodiment implemented using computer system 600, various computer-readable media are involved, for example, in providing instructions to processor 604 for execution. Such media may take many forms, including but not limited to, non-volatile and volatile non-transitory media. Non-volatile non-transitory media includes, for example, optical or magnetic disks, such as storage device 610. Volatile non-transitory media includes dynamic memory, such as main memory 606. Common forms of non-transitory computer-readable media include, without limitation, a floppy disk, a flexible disk, hard disk, magnetic tape, or any other magnetic medium, a CD-ROM, any other optical medium, a RAM, a PROM, and EPROM, a FLASH-EPROM, any other memory chip, memory cartridge or memory stick, or any other medium from which a computer can read.

Various forms of non-transitory computer-readable media may be involved in storing instructions for processing by processor 604. For example, the instructions may initially be stored on a storage medium of a remote computer and transmitted to computer system 600 via one or more communications links. Bus 602 carries the data to main memory 606, from which processor 604 retrieves and processes the instructions. The instructions received by main memory 606 may optionally be stored on storage device 610 either before or after processing by processor 604.

Computer system 600 also includes a communication interface 618 coupled to bus 602. Communication interface 618 provides a communications coupling to a network link 620 that is connected to a local network 622. For example, communication interface 618 may be a modem to provide a data communication connection to a telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. The received code may be processed by processor 604 as it is received, and/or stored in storage device 610, or other non-volatile storage for later execution.

In the foregoing specification, embodiments have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. An apparatus comprising:
one or more processors; and
one or more memories storing instructions which, when processed by one or more processors, cause:
a server transaction processing service, maintaining user sessions for one or more devices, wherein user sessions represent a period of time between receiving a start session request from a particular user and receiving an end session request from the particular user, wherein during a particular user session, service requests are received, wherein the service requests are requests for services that are at least partially performed at one or more external servers;
the server transaction processing service, receiving a request to start a first user session on a first device of the one or more devices;
a server application service, receiving one or more service requests from the first device, wherein each service request of the one or more service requests includes an service request value that describes a transaction charge amount associated with the service request;
the server application service, sending the one or more service requests to the one or more external servers, wherein the one or more external servers implement one or more third party services configured to perform services requested in the one or more service requests;
the server application service, receiving, from the one or more external servers, one or more service request responses that correspond to the one or more service requests, wherein the one or more service request responses comprise a service status value that indicates whether the one or more service requests were successful or unsuccessful;
the server transaction processing service, receiving a request to end the first user session on the first device of the one or more devices;
the server transaction processing service, determining a subset of service requests of the one or more service requests that were unsuccessfully executed;
in response to determining the subset of service requests of the one or more service requests was unsuccessfully executed, generating a refund request for the subset of service requests of the one or more service requests that were unsuccessfully executed, wherein the refund request comprises refunds for service requests that requested services from two or more third party services;
sending the refund request to an authorization and capture service for refund request processing.

2. The apparatus of claim 1, wherein receiving the request to start a first user session on the first device of the one or more devices further comprises generating a transaction record that represents the first user session, wherein the transaction record is used to track associated service requests requested during the first user session.

3. The apparatus of claim 2, wherein receiving the one or more service requests from the first device further comprises generating one or more task records that are associated with the transaction record that represents the first user session, wherein the one or more task records comprise the transaction charge amount associated with each of the one or more service requests.

4. The apparatus of claim 3, wherein generating a refund request for the subset of service requests of the one or more service requests that were unsuccessfully executed comprises generating a total refund value that is calculated by aggregating the transaction charge amounts from a subset of task records of the one or more task records that are associated with the subset of service requests.

5. The apparatus of claim 1, wherein determining a subset of service requests of the one or more service requests further comprises service requests that do not have a corresponding service request response after a specific period of time.

6. The apparatus of claim 1, wherein the one or more memories storing instructions which, when processed by one or more processors, further cause sending a notification message to the first user, notifying the first user that the refund request was generated for service requests that were unsuccessfully executed and sent to the authorization and capture service for processing.

7. The apparatus of claim 1, wherein the one or more memories storing instructions which, when processed by one or more processors, further cause:
receiving a refund response from the authorization and capture service indicating whether the refund request successfully refunded the first user;
sending a notification message to a vendor-administrator managing a particular vendor account associated with the first user session that notifies the vendor-administrator of a successful refund for the first user.

8. One or more non-transitory computer-readable media storing instructions, which, when processed by one or more processors, cause:
a server transaction processing service, maintaining user sessions for one or more devices, wherein user sessions represent a period of time between receiving a start session request from a particular user and receiving an end session request from the particular user, wherein during a particular user session, service requests are received, wherein the service requests are requests for services that are at least partially performed at one or more external servers;
the server transaction processing service, receiving a request to start a first user session on a first device of the one or more devices;
a server application service, receiving one or more service requests from the first device, wherein each service request of the one or more service requests includes an service request value that describes a transaction charge amount associated with the service request;
the server application service, sending the one or more service requests to the one or more external servers, wherein the one or more external servers implement one or more third party services configured to perform services requested in the one or more service requests;
the server application service, receiving, from the one or more external servers, one or more service request responses that correspond to the one or more service requests, wherein the one or more service request responses comprise a service status value that indicates whether the one or more service requests were successful or unsuccessful;
the server transaction processing service, receiving a request to end the first user session on the first device of the one or more devices;
the server transaction processing service, determining a subset of service requests of the one or more service requests that were unsuccessfully executed;
in response to determining the subset of service requests of the one or more service requests was unsuccessfully executed, generating a refund request for the subset of service requests of the one or more service requests that were unsuccessfully executed, wherein the refund request comprises refunds for service requests that requested services from two or more third party services;
sending the refund request to an authorization and capture service for refund request processing.

9. The one or more non-transitory computer-readable media of claim 8, wherein receiving the request to start a first user session on the first device of the one or more devices further comprises generating a transaction record that represents the first user session, wherein the transaction record is used to track associated service requests requested during the first user session.

10. The one or more non-transitory computer-readable media of claim 9, wherein receiving the one or more service requests from the first device further comprises generating one or more task records that are associated with the transaction record that represents the first user session, wherein the one or more task records comprise the transaction charge amount associated with each of the one or more service requests.

11. The one or more non-transitory computer-readable media of claim 10, wherein generating a refund request for the subset of service requests of the one or more service requests that were unsuccessfully executed comprises generating a total refund value that is calculated by aggregating the transaction charge amounts from a subset of task records of the one or more task records that are associated with the subset of service requests.

12. The one or more non-transitory computer-readable media of claim 8, wherein determining a subset of service requests of the one or more service requests further comprises service requests that do not have a corresponding service request response after a specific period of time.

13. The one or more non-transitory computer-readable media of claim 8, further comprising storing instructions, which, when processed by the one or more processors, cause sending a notification message to the first user, notifying the first user that the refund request was generated for service requests that were unsuccessfully executed and sent to the authorization and capture service for processing.

14. The one or more non-transitory computer-readable media of claim 8, further comprising storing instructions, which, when processed by the one or more processors, cause:
receiving a refund response from the authorization and capture service indicating whether the refund request successfully refunded the first user;
sending a notification message to a vendor-administrator managing a particular vendor account associated with the first user session that notifies the vendor-administrator of a successful refund for the first user.

15. A computer-implemented method comprising:
a server transaction processing service, maintaining user sessions for one or more devices, wherein user sessions represent a period of time between receiving a start session request from a particular user and receiving an end session request from the particular user, wherein during a particular user session, service requests are received, wherein the service requests are requests for services that are at least partially performed at one or more external servers;
the server transaction processing service, receiving a request to start a first user session on a first device of the one or more devices;
a server application service, receiving one or more service requests from the first device, wherein each service request of the one or more service requests includes an service request value that describes a transaction charge amount associated with the service request;
the server application service, sending the one or more service requests to the one or more external servers, wherein the one or more external servers implement one or more third party services configured to perform services requested in the one or more service requests;
the server application service, receiving, from the one or more external servers, one or more service request responses that correspond to the one or more service requests, wherein the one or more service request responses comprise a service status value that indicates whether the one or more service requests were successful or unsuccessful;
the server transaction processing service, receiving a request to end the first user session on the first device of the one or more devices;
the server transaction processing service, determining a subset of service requests of the one or more service requests that were unsuccessfully executed;
in response to determining the subset of service requests of the one or more service requests was unsuccessfully executed, generating a refund request for the subset of service requests of the one or more service requests that were unsuccessfully executed, wherein the refund request comprises refunds for service requests that requested services from two or more third party services;
sending the refund request to an authorization and capture service for refund request processing.

16. The computer-implemented method of claim 15, wherein receiving the request to start a first user session on the first device of the one or more devices further comprises generating a transaction record that represents the first user session, wherein the transaction record is used to track associated service requests requested during the first user session.

17. The computer-implemented method of claim 16, wherein receiving the one or more service requests from the first device further comprises generating one or more task records that are associated with the transaction record that represents the first user session, wherein the one or more task records comprise the transaction charge amount associated with each of the one or more service requests.

18. The computer-implemented method of claim 17, wherein generating a refund request for the subset of service requests of the one or more service requests that were unsuccessfully executed comprises generating a total refund value that is calculated by aggregating the transaction charge amounts from a subset of task records of the one or more task records that are associated with the subset of service requests.

19. The computer-implemented method of claim 15, wherein determining a subset of service requests of the one or more service requests further comprises service requests that do not have a corresponding service request response after a specific period of time.

20. The computer-implemented method of claim 15, further comprising:
receiving a refund response from the authorization and capture service indicating whether the refund request successfully refunded the first user;
sending a notification message to a vendor-administrator managing a particular vendor account associated with the first user session that notifies the vendor-administrator of a successful refund for the first user.
